(19) United States
(12) Patent Application Publication
(10) Pub. No.: US 2010/0141905 A1
(43) Pub. Date: Jun. 10, 2010

(54) CONTROLLABLE LIGHT ARRAY FOR PROJECTION IMAGE DISPLAY

(75) Inventor: Elliot Burke, Goleta, CA (US)

Correspondence Address: Stephen B. Salai, Esq.;Harter Secrest & Emery LLP, 1600 Bausch & Lomb Place, Rochester, NY, 14604-2711, US

(73) Assignee: VUZIX CORPORATION, Rochester, NY (US)

(21) Appl. No.: 12/631,073

(22) Filed: Dec. 4, 2009

Related U.S. Application Data
(60) Provisional application No. 61/120,252, filed on Dec. 5, 2008.

(51) Int. Cl. G03B 21/20

(52) U.S. Cl. 353/85; 353/121

(57) ABSTRACT

Projection image displays for projecting virtual images into viewers' eyes include an array of separately activatable light sources located conjugate to a pupil of the displays. Illumination patterns produced within the arrays are symmetrically replicated within viewing eyeboxes of the displays. The illumination patterns can be varied to alter the size or position of the pupil within the eyeboxes.

### TECHNICAL FIELD

The invention relates to illumination systems of projection image displays, particularly near-eye displays, and to illumination systems responsive to changes in eye position for optimizing brightness of the displays throughout a range of different eye positions.

### BACKGROUND OF THE INVENTION

Projection image displays, such as near-eye displays used in head-mounted display systems, project virtual images to viewer's eyes. The images are generally formed by spatial light modulators that selectively attenuate or redirect light from an illuminator on a pixel-by-pixel basis. Imaging optics of the displays magnify the images formed by the spatial light modulators or other display engines as virtual images to the viewer's eyes.

Bright high-resolution images are preferred. Efficient use of light from the illuminator is important for limiting power consumption of the displays. In addition, the bright virtual images should be visible through a range of eye positions to accommodate variation in the alignment of the projection image displays with viewer's eyes. Particularly for binocular head-mounted displays, the virtual images must be visible throughout a range of different interpupillary distances expected among the wearers of the head-mounted displays.

The pupil of the projection displays through which the virtual image is visible and which is referred to as an eyebox is generally larger than the normal pupil size of the viewer's eyes. In any one viewing position, only a limited portion of the light filling the pupil eyebox contributes to forming images within the viewer's eyes. Generally, either the projection displays must be overpowered, which adds to the cost and complexity of the displays, or a dimmer image must be accepted. The overpowering of the projection displays can also produce stray light that can reduce display contrast.

### SUMMARY OF THE INVENTION

The invention in one or more of its preferred embodiments provides a projection image display with a controllable array of light sources that can be activated individually or in combination to project virtual images throughout a range of positions within an eyebox of the projection image displays. Illumination and imaging optics of the display are arranged so than a pupil within the display eyebox is substantially conjugate to the array of light sources. Thus, the individual light sources fill different portions of the pupil eyebox. The individual light sources or a combination of the light sources can be activated, e.g., powered, to fill a limited area of the display eyebox corresponding to the location of a viewer's pupil within the eyebox. As a result, the viewer can be presented with a bright virtual image while reducing the overall amount of light that would otherwise be required to fill the entire pupil eyebox. Brighter images with increased contrast and reduced power consumption can all be realized.

The projection image display preferably includes an adjuster under the control of the viewer for changing illumination patterns of the light sources within the array to optimize viewing conditions. For example, the adjuster can be used to activate the light sources in one or more sequences for progressively shifting the optimum viewing position through the eyebox. In doing so, the total amount of light available for reaching the eyebox from the illuminator can be held substantially constant despite changes in the location within the eyebox at which viewing is optimized.

Typically, eye positions vary substantially more in the horizontal direction due to differences in interpupillary distances between viewers. Vertical misalignments can be mechanically adjusted for proper alignment with the viewer's eyes. For example, a nose bridge adjustment or tilt of a visor can accommodate for the vertical misalignment.

One embodiment of the inventions features five separately powered light emitting diodes (LEDs) arranged in a single row for each eye. The LEDs are oriented so that the emission height dimension of the LEDs as propagated through the projection image display fills the vertical dimension of the eyebox while emissions from the entire row of LEDs are required to fill the horizontal dimension of the eyebox. To accommodate a range of different interpupillary distances without filling the entire horizontal dimension of the eyebox, the LED's can be individually powered in sequence from left to right or right to left under the control of the viewer to choose the LED whose light output that best matches the viewer's pupil position. For providing a more continuous horizontal translation of the illuminated position within the eyebox, one LED that starts fully powered can be powered down to the extent that an adjacent LED that starts unpowered is correspondingly powered up so that the total light output of the adjacent LEDs remains substantially constant through the transition. As a practical matter, interim shifts half-powering adjacent LEDs can provide enough fill positions to present optimized viewing conditions across the eyebox.

The adjuster for progressively shifting the optimum fill position within the eyebox can be provided in the form of buttons, a slider, wheels, or any other input device that would allow the viewer to select which LED or LED combination that would provide the optimum illumination. The adjuster can be located together with the projection image display on a common head-mounted frame or on a separate control box that can also be used for making other adjustments including video or audio adjustments associated with the operation of the projection video display.

While manual adjustment of the eyebox fill position is preferred as a cost effective way of achieving optimum illumination conditions, automatic adjustments are also possible. For example, known eye position sensing systems can be used to locate the relative position of the viewer's pupil within the eyebox and the LED or LED combination best positioned for filling the viewer's pupil can be automatically activated. One such eye-sensing system could use infrared light emitters and sensors placed in close proximity to the backlight LEDs for monitoring light retroreflected from the viewer's retina. The LED or LEDs located closest to the highest concentration of retroreflected light returned to the conjugate illumination plane can be powered to project the desired virtual image through the viewer's pupil.

The infrared light provided by the infrared light emitters passes through the optical system of the projection image display and the viewer's pupil and retro-reflects off the viewer's retina and back through the viewer's pupil and the display optical system. If the viewer's eye is not in alignment with the backlight LED, the returned light is substantially less than if the eye was directly in the optical path of the infrared LED. According to another approach, the sclera of the eye can be detected visibly.

The placement and sensitivity of the light sensors is preferably such that the nature of the returned light can predict the placement of the eye. If the alignment is off, the system can change to different LED or a different combination of LEDs. A simple maximization process can be used to choose the proper LED based on the viewer's eye position.

### BRIEF DESCRIPTION OF THE DRAWING FIGURES

FIG. 1 is a schematic diagram of a projection image display in accordance with the invention showing a path of light rays from an on-axis light source within an array of light sources through the display to a pupil at a central position within an eyebox.

FIG. 2 is a schematic diagram of the same projection image display showing a path of light rays from a horizontally displaced light source within the array of light sources through the display to a pupil near one side of the eyebox.

FIG. 3 is a schematic diagram of the same projection image display showing paths of light rays from three horizontally displaced light sources within the array of light sources through the display to an enlarged pupil for filling the horizontal extent of the eyebox.

FIG. 4 is a schematic diagram showing an eyeglass-type frame mounting a pair of the projection image displays for binocular viewing and a control box for controlling the displays including illumination patterns within the projection image displays.

FIGS. 5A through 5C are schematic diagrams showing a switching system for progressively powering light sources across the array.

### DETAILED DESCRIPTION OF THE INVENTION

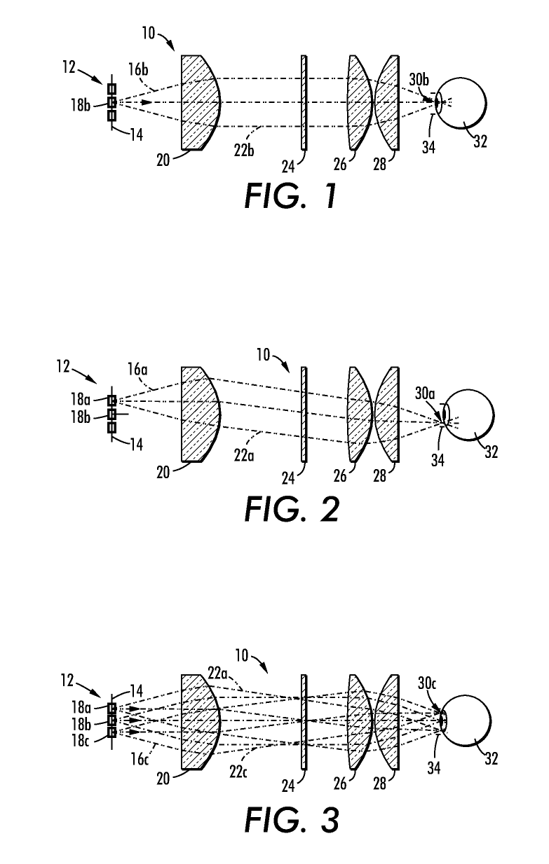

The projection image display 10 of FIGS. 1-3 includes a controllable light source array 12 at an illumination plane 14. Within an illuminator portion of the display 10, one or more of light rays 16a, 16b, and 16c from one or more of a plurality of light sources 18a, 18b, and 18c of the array 12 are collected by condenser lens 20 and formed into nearly collimated light beams 22a, 22b, and 22c that impinge on a spatial light modulator 24. A control system (not shown) controls the spatial light modulator 24 on a pixel-by-pixel basis for forming video patterns by absorbing or transmitting the light. Within an imaging portion of the display 10, imaging lenses 26 and 28 project a magnified virtual image of the video patterns through a pupil 30a, 30b, or 30c and into a viewer's eye 32. The projected virtual image is completed by the optics of the viewer's eye 32 on the viewer's retina (not shown). An eyebox 34 surrounding the pupil 30b of the display 10 references a range of positions of the viewer's eye 32 through which the entire virtual image can be viewed.

The light sources 18a, 18b, and 18c, are preferably formed by light emitting diodes (LEDs) that can be separately activated for emitting light through a range of directions over limited areas within the illumination plane 14. The light source array 12 can be formed by mounting the individual LEDs or other light sources in close proximity or can be formed as an integrated structure within which the light sources are collectively formed but individually addressable.

The spatial light modulator 24 preferably comprises a controllable array of liquid crystal display (LCD) elements, providing individually addressable pixels for producing the desired light patterns in response to the video signal. Other spatial light modulators useful for purposes of the invention include grating light valve (GLV) technologies and digital light processing (DLP) technologies such as digital micromirror devices (DMD).

Although the condenser lens 20 and the imaging lenses 26 and 28 are depicted as refractive elements, similar functions could be performed by reflective or diffractive elements. The condenser lens 20 of the illuminator portion is related to the imaging lenses 26 and 28 of the imaging portion of the display 10 so that the pupils 30a through 30c are all formed conjugate to the illumination plane 14. As a result, the individual light outputs from the light sources 18a, 18b, and 18c are reproduced in corresponding positions within the eyebox 34. In FIG. 2, light from the horizontally displaced light source 18a is reformed through the pupil 30a at one end of the eyebox 34. In FIG. 3, light from all three depicted light sources 18a, 18b, and 18c is traced through a range of positions filling the pupil 30c, which corresponds to the entire vertical extent of the eyebox 34.

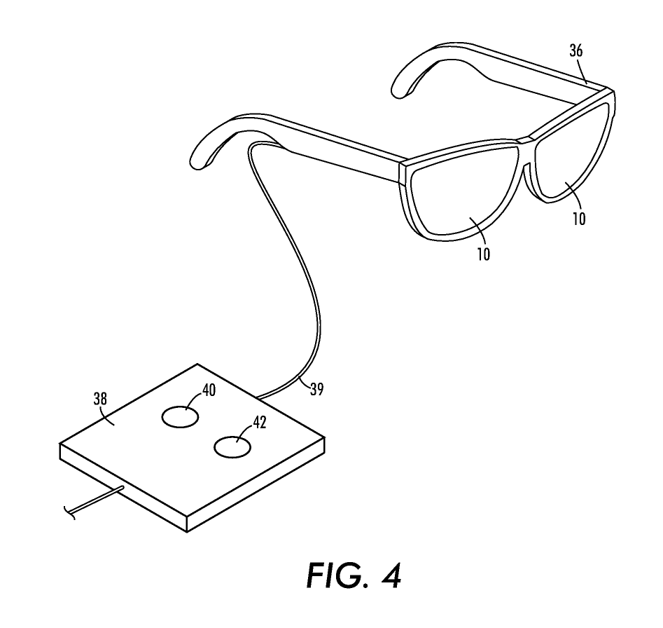

FIG. 4 depicts a pair of projection image displays 10 supported within an eyeglass type head-mountable frame 36. A control box 38 is wired through power and communications cable 39 or otherwise connected to the frame 36 and the projection image displays 10 for controlling the operation of the displays 10. For example, switches 40 and 42 are shown on the control box 38, which can be used separately or together for controlling the displays 10, including the light sources 18a, 18b, and 18c within the array 12. The switches 40 and 42 can take a variety of forms including push-button, toggle, selector, rocker, slider, and joystick switches. Other manual controls, including voice or pressure activated controls, can be used to control the light output from the light sources 18a, 18b, and 18c within the array 12, particularly through one or more predetermined sequences. For example, the light sources can be illuminated in a sequence from left to right and right to left or top to bottom and bottom to top depending on the position or orientation of the switch. Sequential illumination in any direction would also be possible through the use of a joystick or similar control. The light sources within the arrays of binocular projection image displays can be controlled separately or together. For example, the light sources of the two displays can be adjusted together to symmetrically increase or decrease the separation between pupils of the displays to adjust for different interpupillary distances between viewers' eyes.

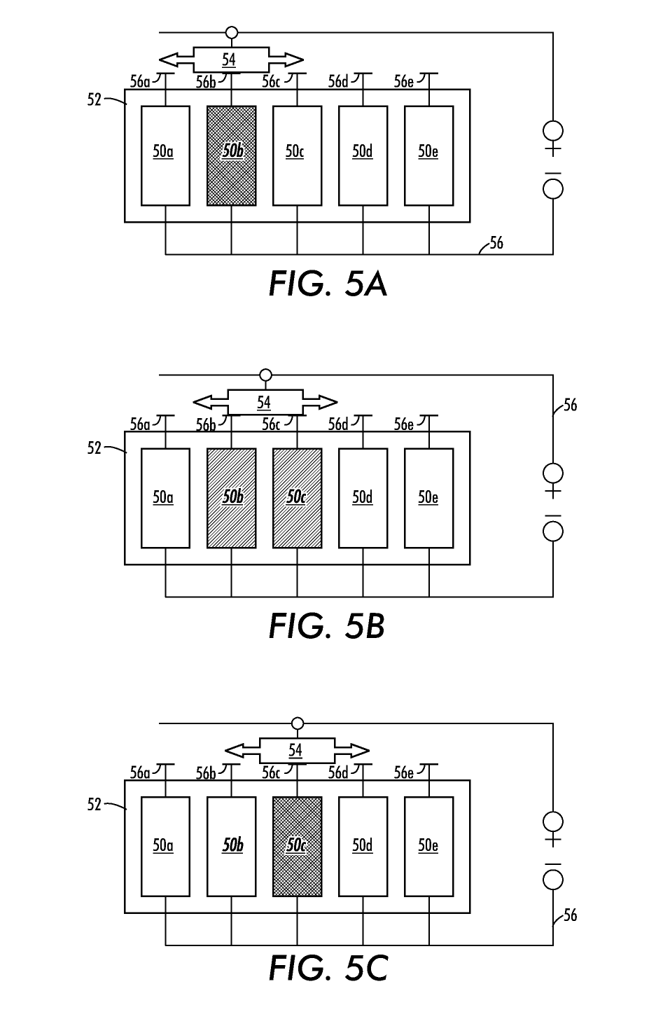

FIGS. 5A through 5C show a portion of a sequence for horizontally shifting the activation of light sources 50a through 50e within an array 52 of a similar projection image display for correspondingly changing the pupil position at which virtual images are projected into an eyebox of the display. As a sliding switch 54 is shifted horizontally across the array 52 into successive engagements with contacts 56a through 56e, a circuit 56 is completed for powering the light sources 50a through 50e, such as the light source 50b shown for the switch position of FIG. 5A and light source 50c as shown for the switch position of FIG. 5C. When the switch 54 is located intermediate between two light sources, as shown in FIG. 5B, the switch can engage adjacent contacts, such as the contacts 56b and 56c, for partially powering the adjacent light sources 50b and 50c.

The invention includes embodiments that allow the position of a pupil of the display system to be moved to different positions within an eyebox by turning on different light sources located in a plane conjugate to the common plane of the pupil and eyebox. Beyond the use of a switch or other type of controller, the adjustments can be made with no moving parts. The ability to align the pupil of the display with the pupil of a viewer's eye allows for the projection of bright virtual images with minimal power consumption. The reduction in unused light within the eyebox not only reduces power consumption but also enhances the contrast of the projected virtual images.

The individually controllable light sources can be arranged in one-dimensional arrays, particularly horizontal arrays for accommodating variations in interpupillary distances, or two-dimensional arrays for moving the pupil of the displays both vertically and horizontally within the display eyeboxes. A depth dimension could also be exploited for adjusting the location of the pupil in the viewing direction. The number of light sources can be varied depending upon variables such as the size of the light sources and the magnification of the illumination source. The number of light sources powered at any one time for emitting light can also be adjusted to control the size and shape of the pupil. For example, a larger or smaller pupil may be needed for optimizing the presentation of certain types of projected images.

1. A projection image display system comprising
an illumination system,
a spatial light modulator illuminated by the illumination system, the spatial light modulator having individually addressable pixels for forming image patterns,
an imaging system for projecting a virtual image of the image patterns through a pupil within an eyebox,
an array of separately activatable light sources within the illumination system positioned optically conjugate to the pupil within the eyebox, and
a control system for selectively activating the light sources for adjusting a size or position of the pupil within the eyebox.

2. The display system of claim 1 in which the array of separately activatable light sources is formed as an integrated structure within which the light sources are individually addressable.

3. The display system of claim 1 in which the separately activatable light sources are spaced horizontally within the array for accommodating variations in interpupillary distances.

4. The display system of claim 3 in which an array of separately activatable light sources includes a two-dimensional array of the separately activatable light sources for moving the pupil both vertically and horizontally within the eyebox.

5. The display system of claim 3 in which an array of separately activatable light sources includes activatable light sources relatively displaced in a depth dimension for moving the pupil along a viewing axis.

6. The display system of claim 1 in which the control system provides for varying a number of the separately activatable light sources powered at any one time to adjust the size and shape of the pupil.

7. The display system of claim 1 in which the control system includes an actuator for powering the separately activatable light sources through one or more predetermined sequences.

8. A projection image display system comprising
a pair of image displays each having an illumination system, a spatial light modulator illuminated by the illumination system for forming image patterns, an imaging system for projecting a virtual image of the image patterns through a pupil within an eyebox, an array of separately activatable light sources within the illumination system positioned optically conjugate to the pupil,
the pair of displays supported within a head-mountable frame for positioning each of the eyeboxes of the displays in front of a viewer's eyes, and
a control system that selectively activates the light sources within both displays in a pattern to increase or decrease a separation between pupils of the displays for accommodating different interpupillary distances between the viewers' eyes.

9. The display system of claim 8 in which the control system selectively activates the light sources within both displays in a symmetric pattern.

10. The display system of claim 9 in which a total amount of power for activating the light sources remains constant between patterns that increase or decrease the separation between pupils of the displays.

11. The display system of claim 8 in which each of the arrays of separately activatable light sources includes a two-dimensional array of the separately activatable light sources for moving the pupil both vertically and horizontally within the eyebox.

12. The display system of claim 8 in which each of the arrays of separately activatable light sources includes activatable light sources relatively displaced in a depth dimension for moving the pupil along a viewing axis.

13. The display system of claim 8 in which the control system provides for varying a number of the separately activatable light sources powered at any one time within each of the arrays to adjust the size and shape of the pupils.

14. A method of providing for adjusting a position within an eyebox at which a pupil of a virtual display is formed comprising steps of
arranging illumination and imaging optics of the virtual display so than the pupil of the virtual display is substantially conjugate to an array of separately activatable light sources,
connecting a control system to the array to provide for selectively activating the light sources with the array to adjust the position of the virtual display pupil within the eyebox.

15. The method of claim 14 including arranging the control system for powering the separately activatable light sources through one or more predetermined sequences.

16. The method of claim 14 including arranging the control system for varying a number of the separately activatable light sources powered at any one time to adjust the size and shape of the pupil.
